(19) United States
(12) Patent Application Publication
(10) Pub. No.: US 2016/0116766 A1
(43) Pub. Date: Apr. 28, 2016

(54) DETACHABLE IMAGE INPUT/OUTPUT DEVICE

(71) Applicant: Ossong Internatioanl Co., Ltd., Hsinchu City (TW)

(72) Inventors: CHANG-YO HSUAN, Hsinchu City (TW); HSIN-KUO HO, Hsinchu City (TW)

(21) Appl. No.: 14/521,934

(22) Filed: Oct. 23, 2014

(51) Int. Cl. G02C 11/00; H04N 7/18; H04N 5/225

(52) U.S. Cl. CPC G02C 11/10; H04N 5/2252; H04N 5/2253; H04N 7/183

(57) ABSTRACT

Disclosure is a detachable image input/output device which is applicable to detachably connect to one of temples of a glasses frame, and comprises an L-shaped body, an image capture module and an image display module. A side of the L-shaped body has a connecting part, and the side of the L-shaped body corresponds to the temple, the L-shaped body connects to the temple by the connection part, an end of the L-shaped body has a bending part, and the bending part of the L-shaped body being bent to a direction perpendicular to the temple. The image capture module is disposed at the bending part of the L-shaped body and adjacent to the bending position of the L-shaped body. The image display module is disposed at the bending part of the L-shaped body and far away the bending position of the L-shaped body.

### BACKGROUND OF THE INVENTION

1. Field of the Invention

The present invention relates to an image input/output device, in particular with respect to a detachable image input/output device which detachably connects to a temple of a glasses frame by a connecting part of an L-shaped body.

2. Description of the Related Art

For the sake of technology is burgeoning, smart devices, such as smart phone and tablet and so on have been available to all in daily life; in the meanwhile, as the functions of the smart devices keep upgrading, demands for the related smart devices are increasing gradually.

As for as the smart devices' users are concerned, it is of convenience to use online communication, play games and deal with various tasks by smart phones, but in case things are tracked back to where it stated from, it can be found that the current smart devices only work when being held in one's hand, that is to say, the operative range is limited within user's hand, otherwise the practicability is disabled.

Furthermore, the user wants to take a photo or make a record whilst the smart device is placed in somewhere (e.g. in handbag), neither of the functions is enabled until the smart device is available to the user. Consequently, in term of usage, when the user has to use certain functions of the smart device promptly, the current smart devices are incapable of satisfying with the demands of the user.

As a result, how to overcome the aforementioned shortcomings to promote the smart devices becoming more convenient and user friendly in the functions is a task which the industry has to resolve.

### SUMMARY OF THE INVENTION

In view of the technical problems of the prior art, purpose of the present invention is to provide a detachable image input/output device to solve the confronted shortcomings.

According to the purpose of the present invention, it may provide a detachable image input/output device, applicable to detachably connect to one of temples of a glasses frame, comprising: an L-shaped body, an image capture module and an image display module. a side of the L-shaped body may have a connecting part, and the side of the L-shaped body corresponds to the temple, the L-shaped body may connect to the temple by the connection part, an end of the L-shaped body may have a bending part, and the bending part of the L-shaped body may bend to a direction perpendicular to the temple. The image capture module may be disposed at the bending part of the L-shaped body and adjacent to the bending position of the L-shaped body. The image display module may be disposed at the bending part of the L-shaped body and far away the bending position of the L-shaped body.

Preferably, the detachable image input/output device may comprise a connector disposed on the temple of the glasses frame, and the L-shaped body and the temple may connect with each other by the connecting part connecting to the connector.

Preferably, a side of the connector may be a connecting surface, the side of the connector corresponds to the L-shaped body, and another side of the connector may have at least one housing part, the connecting surface may connect to the connecting part of the L-shaped body, the at least one housing part may have a housing aperture and the connector and the temple may connect with each other by the housing aperture of the at least one housing part housing on the temple of the glasses frame.

Preferably, inner wall of the housing aperture may have a convex part.

Preferably, a side of the L-shaped body may have a concave part, and the side of the L-shaped body opposes the temple, and the concave part may be disposed with a touch panel module.

Preferably, the detachable image input/output device may further comprise a plurality of control keys disposed on top side of the L-shaped body.

Preferably, the plurality of control keys may comprise an image capture on-off switch disposed on the top side of the L-shaped body, and when applying an external force to the image capture on-off switch, the image capture module may execute corresponding actions.

Preferably, the detachable image input/output device may further comprise an audio input/output module outputting or inputting an audio.

Preferably, the audio input/output module may be disposed at a side of the L-shaped body.

Preferably, the plurality of control keys may comprise a volume control key disposed on the top side of the L-shaped body, and when applying an external force to the volume control key, the audio input/output module may adjust the volume of the audio.

To sum up, the detachable image input/output device of the present invention and the temple of the glasses frame are able to detachably connect with each other by the L-shaped body having the connecting part which contributes to the user connecting or dismantling the detachable image input/output device to or from the glasses frame according to the usage conditions.

### BRIEF DESCRIPTION OF THE DRAWINGS

FIG. 1 is the first schematic diagram of the detachable image input/output device of the present invention.

FIG. 2 is a schematic diagram of the connector of the detachable image input/output device of the present invention.

FIG. 3 is a top view of the detachable image input/output device of the present invention.

FIG. 4 is a side view of the detachable image input/output device of the present invention.

FIG. 5 is a front view of the detachable image input/output device of the present invention.

### DETAILED DESCRIPTION OF THE PREFERRED EMBODIMENTS

Hereinafter, embodiments of the present invention will be described in detail with reference to the accompanying drawings so that those skilled in the art to which the present invention pertains can realize the present invention. As those skilled in the art would realize, the described embodiments may be modified in various different ways, all without departing from the spirit or scope of the present invention.

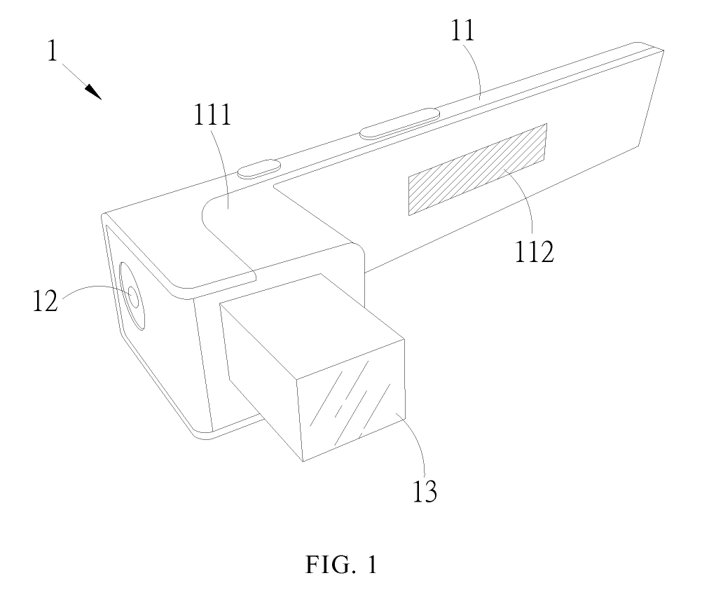

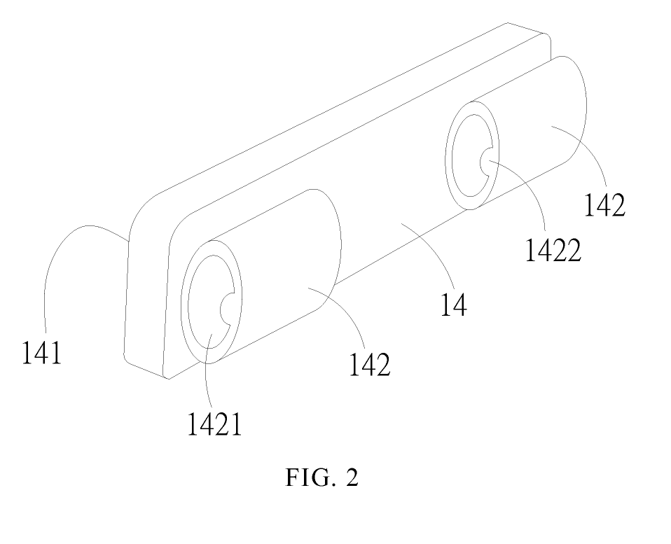

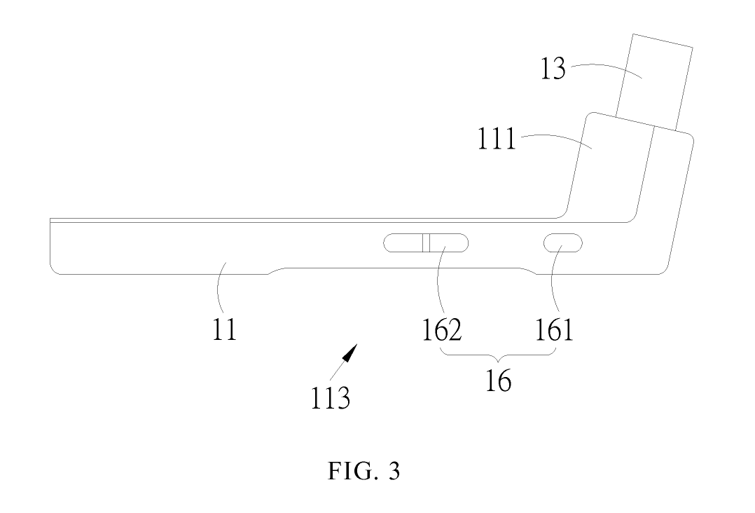

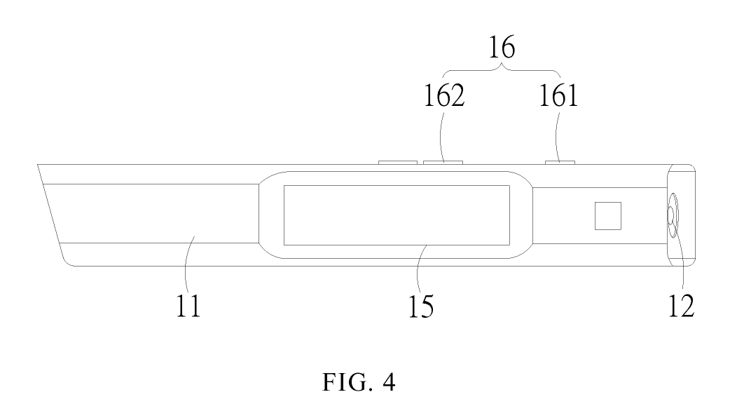

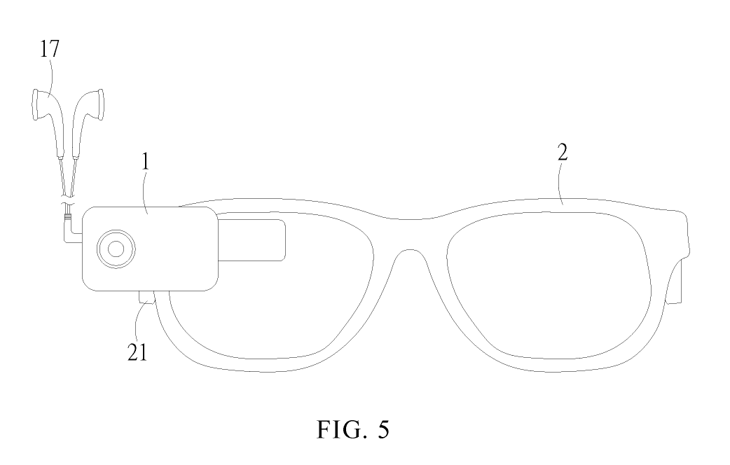

Please refer to FIG. 1 to FIG. 5, FIG. 1 is the first schematic diagram of the detachable image input/output device of the present invention, FIG. 2 is a schematic diagram of the connector of the detachable image input/output device of the present invention, FIG. 3 is a top view of the detachable image input/output device of the present invention, FIG. 4 is a side view of the detachable image input/output device of the present invention and FIG. 5 is a front view of the detachable image input/output device of the present invention. As the FIGS. show, the detachable image input/output device 1 of the present invention is applicable to detachably connect to one of temples 21 of a glasses frame 2, and comprises an L-shaped body 11, an image capture module 12 and an image display module 13. a side of the L-shaped body 11 has a connecting part 112, and the side of the L-shaped body 11 corresponds to the temple 21, the L-shaped body 11 connects to the temple 21 by the connection part 112, an end of the L-shaped body 11 has a bending part 111, and the bending part 111 of the L-shaped body 11 being bent to a direction perpendicular the temple. The image capture module 12 is disposed at the bending part 111 of the L-shaped body 11 and adjacent to the bending position of the L-shaped body 11. The image display module 13 is disposed at the bending part 111 of the L-shaped body 11 and far away the bending position of the L-shaped body 11.

More specifically, if the glasses frame 2 has a lens, the image display module 13 is disposed in front of the lens; in other words, between the image display module 13 and user's eyes is the lens.

On the other hand, capturing direction of the image capture module 12 and line of vision of the user are the same.

Continuously, the detachable image input/output device 1 of the present invention connects to the temple 21 of the glasses frame 2 by the connector 112 of the L-shaped body 11; moreover, if take the connecting part 112 of the L-shaped body 11 having magnetic element (e.g. magnet) for example, the connecting position of the temple 21 and the connecting part 112 has a metal element so that the connecting part 112 of the L-shaped body 11 connects to the temple 21 through magnetic force. However, the preceding description is taken as examples, it shall not subject to this restriction.

In addition, as FIG. 2 shows, the detachable image input/output device 1 further comprises a connector 14 disposed on the temple 21 of the glasses frame 2, and the L-shaped body 11 and the connector 14 connect with each other by the connector 112 so that the detachable image input/output device 1 connects to the temple 21.

More specifically, a side of the connector 14 is a connecting surface 141 , and the side of the connector 14 corresponds to the L-shaped body 11, and another side of the connector 14 has at least one housing part 142, the connecting surface 141 connects to the connecting part 112 of the L-shaped body 11, the at least one housing part 142 has a housing aperture 1421 and the connector 14 and the temple connect with each other by the housing aperture 1421 of the at least one housing part 142 housing on the temple of the glasses frame.

Wherein, preferably, shape of the housing aperture 1421 is elliptical shape, the long axis corresponds to the width of the temple 21, and inner wall of the housing aperture 1421 has a convex part 1422, and frictional force between inner wall of the housing aperture 1421 and the temple 21 is increased by the convex part 1422, so that the connection between the connector 14 and the temple 21 becomes more solid.

Subsequently, a side of the L-shaped body 11 of the detachable image input/output device 1 of the present invention has a concave part 113, and the side of L-shaped body opposes the temple 21, the concave part 113 is disposed with a touch panel module 15, and the touch panel module 15 displays operating interface and options so as to set parameters of the detachable image input/output device 1 and control the image capture module 12 and the image display module 13.

Here is a footnote that the detachable image input/output device 1 further comprises a plurality of control keys 16 disposed on top side of the L-shaped body 11.

Furthermore, the plurality of control keys 16 comprises an image capture on-off switch 161 disposed on the top side of the L-shaped body 11, and when applying an external force to the image capture on-off switch 161, the image capture module 12 executes photo operation or record operation.

On the other hand, the plurality of control keys 16 comprises a volume control key 162 disposed on the top side of the L-shaped body 11; and the detachable image input/output device 1 comprises an audio input/output module 17 disposed at a side of the L-shaped body 11 outputting or inputting audio; and when applying an external force to the volume control key 162, the volume of the audio of the audio input/output module 17 is adjusted.

In conclusion, the detachable image input/output device of the present invention is able to detachably connect to the temple of the glasses frame by the L-shaped body having the connector so as to contribute to the user connecting or dismantling the detachable image input/output device to or from the glasses frame according to the usage conditions; in addition, the holding mode is unnecessary to the user when using the device, and thus the convenience is promoted greatly.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A detachable image input/output device applicable to detachably connect to one of temples of a glasses frame, comprising:
a side of an L-shaped body having a connecting part, and the side of the L-shaped body corresponds to a side of the temple, the L-shaped body connecting to the temple by the connection part, an end of the L-shaped body having a bending part, and the bending part of the L-shaped body being bent to a direction perpendicular to the temple;
an image capture module disposed at the bending part of the L-shaped body and adjacent to the bending position of the L-shaped body; and
an image display module disposed at the bending part of the L-shaped body and far away the bending position of the L-shaped body.

2. The detachable image input/output device of claim 1, further comprising a connector disposed on the temple of the glasses frame, and the L-shaped body and the temple connecting with each other by the connecting part connecting to the connector.

3. The detachable image input/output device of claim 2, wherein a side of the connector is a connecting surface, and the side of the connector corresponds to the L-shaped body, and another side of the connector has at least one housing part, the connecting surface connects to the connecting part of the L-shaped body, the at least one housing part has a housing aperture and the connector and the temple connecting with each other by the housing aperture of the at least one housing part housing on the temple of the glasses frame.

4. The detachable image input/output device of claim 3, wherein inner wall of the housing aperture has a convex part.

5. The detachable image input/output device of claim 1, wherein a side of the L-shaped body has a concave part, and the side of the L-shaped body opposes the temple, and the concave part is disposed with a touch panel module.

6. The detachable image input/output device of claim 1, further comprising a plurality of control keys disposed on top side of the L-shaped body.

7. The detachable image input/output device of claim 6, wherein the plurality of control keys comprises an image capture on-off switch disposed on the top side of the L-shaped body, and when applying an external force to the image capture on-off switch, the image capture module executes corresponding actions.

8. The detachable image input/output device of claim 6, further comprising an audio input/output module outputting or inputting an audio.

9. The detachable image input/output device of claim 8, wherein the audio input/output module is disposed at a side of the L-shaped body.

10. The detachable image input/output device of claim 9, wherein the plurality of control keys comprises a volume control key disposed on the top side of the L-shaped body, and when applying an external force to the volume control key, the audio input/output module adjusts the volume of the audio.
